(19) United States
(12) Patent Application Publication
(10) Pub. No.: US 2014/0373607 A1
(43) Pub. Date: Dec. 25, 2014

(54) Apparatus for Determining and/or Monitoring at least one Process Variable

(71) Applicant: Endress + Hauser Gmbh + Co. KG, Maulburg (DE)

(72) Inventors: Max Bauer, Rheinfelden (DE); Tobias Brengartner, Emmendingen (DE); Martin Urban, Lorrach (DE); Michael Siegel, Karlsruhe (DE)

(21) Appl. No.: 14/368,611

(22) PCT Filed: Nov. 22, 2012
(86) PCT No.: PCT/EP2012/073380

§ 371 Date: Jun. 25, 2014

(30) Foreign Application Priority Data
Dec. 28, 2011 (DE) 10 2011 090 014.4

(51) Int. Cl. G01N 11/16; G01F 23/22

(52) U.S. Cl. CPC G01N 11/16; G01F 23/22; G01N 2011/0013
USPC 73/64.53

(57) ABSTRACT

Apparatus for determining and/or monitoring at least one process variable of a medium in a container, comprising: a mechanically oscillatable unit; an electromechanical transducer unit, which has at least one piezoelectric or inductive, transducer element, which excites the oscillatable unit by means of an exciter signal to execute mechanical oscillations and which receives oscillations from the oscillatable unit and converts them into an electrical, received signal; a reference element having a first component of electrically adjustable size, wherein the reference element is connected in parallel with the electromechanical transducer unit and supplied with the same exciter signal and produces a reference signal uninfluenced by the oscillations of the oscillatable unit, and an electronics unit, which extracts a wanted signal from the received signal and the reference signal and, based on the wanted signal, determines and/or monitors the process variable. According to the invention, the electromechanical transducer unit includes a second component of electrically adjustable size.

The present invention relates to an apparatus for determining and/or monitoring at least one process variable with a mechanically oscillatable unit. The process variable is, for example, the fill level, the density, or the viscosity of a medium in a container.

Known in the state of the art are so called oscillatory forks, which serve for monitoring a limit level of a liquid in a container, or for measurement of density or viscosity. The mechanically oscillatable unit in the form of the oscillatory fork is excited by an electrodynamic, especially inductive or piezoelectric, transducer unit to execute resonant, mechanical oscillations. There are transducer units with only one piezoelement (e.g. DE 3931453 C1) but also transducer units with at least one exciter piezo and one receiver piezo (e.g. DE 19720519 A1). In the case of inductively operating systems, two separate coils serve as transmitter and receiver. Disadvantageous in the case of such inductively driven systems is that the voltage induced by the sending coil in the receiving coil is strongly superimposed on the actual measurement signal.

For fill level measurement, it is detected, for example, whether the oscillation frequency in the case of resonant exciting lies below or above a predetermined limit frequency. If the oscillation frequency exceeds the limit frequency, the oscillatable unit is oscillating in air; if the oscillation frequency subceeds, or falls beneath, the limit frequency, the oscillatable unit is covered with medium.

In so-called one-piezo technology, the same piezoelement serves as transmitter and receiver of the mechanical oscillations of the oscillatable unit. Serving for supplying power to the piezoelement is, as a rule, an electrical alternating voltage having a rectangular waveform. In supplying a piezoelement with such a rectangular signal, the piezo capacitance undergoes reverse poling at each edge of the rectangular signal. This leads to charging and discharging, electrical currents. Additionally flowing is an electrical current corresponding to the mechanical movements. For evaluating the mechanical oscillations, the resulting electrical current is converted via a resistor into a voltage. The charging and discharging electrical currents represent undesired disturbance signals in the evaluation.

In Offenlegungsschrift DE 19720519 A1, these disturbance signals are compensated by a reference capacitor, which is connected in parallel with the transducer element and is supplied with the same exciter signal. The reference capacitor is, in such case, selected in such a manner that its capacitance corresponds to that of the transducer element, whereby the reference capacitor has the same charging and discharging behavior as the transducer element. By taking the difference of the voltages across the transducer element and the reference capacitor, a signal is obtained, which bears only the information concerning the mechanical oscillations. Problematic in the case of this solution are the different temperature and aging behaviors of transducer element and reference capacitor.

Known from Offenlegungsschrift DE 102008050266 A1 is an oscillatory fork, in the case of which, instead of the reference capacitor, a piezoelectric compensation element is placed in a parallel branch. Aging and temperature behavior are, consequently, equal in each case. If the temperature of the transducer element and that of the compensation element differ, then the time constants of the two elements differ and a complete compensation is not possible.

In the currently unpublished German Patent Application No. 102010030791.2 (US 20130104647 (A1)), a system is described having a compensation element composed of a controllable resistor and a fixedly set capacitor, wherein the time constant of the compensation element is permanently matched by means of the controllable resistance to that of the transducer element.

This embodiment offers furthermore the possibility of registering the temperature of the transducer element. Knowledge of the temperature is advantageous for increasing the accuracy of measurement of the apparatus. For example, the stiffness of the oscillatable unit changes with temperature and therewith also the resonant frequency, oscillation amplitude and phase shift between exciter signal and received signal. The temperature dependence of the oscillation characteristics leads to a temperature dependent accuracy of measurement of the apparatus. With knowledge of the temperature, for example, the limit frequency can be correspondingly adjusted for fill-level monitoring.

An object of the invention is to provide an apparatus of the above described type, which has a further increased accuracy of measurement.

The object is achieved by an apparatus as defined in the preamble of claim 1, wherein the electromechanical transducer unit has a second component of electrically adjustable size.

The apparatus for determining and/or monitoring at least one process variable of a medium in a container possesses a mechanically oscillatable unit and an electromechanical transducer unit, which has at least one piezoelectric transducer element or inductive transducer element, which excites the oscillatable unit by means of an exciter signal to execute mechanical oscillations and which receives oscillations from the oscillatable unit and converts them into an electrical, received signal, wherein the received signal exhibits a superpositioning of a disturbance signal and a wanted signal representing the oscillations. Furthermore, the apparatus includes a reference element having a component of electrically adjustable size, wherein the reference element is connected in parallel with the electromechanical transducer unit and supplied with the same exciter signal and produces a reference signal uninfluenced by the oscillations of the oscillatable unit. Furthermore, the apparatus includes an electronics unit, which in the case of a supplying of the electromechanical transducer unit and the reference element with the exciter signal extracts the wanted signal from the received signal and the reference signal and, based on the wanted signal, determines and/or monitors the process variable. According to the invention, the electromechanical transducer unit includes a second component of electrically adjustable size. The second component of electrically adjustable size associated with the transducer unit is preferably of equal construction to the first component of electrically adjustable size of the reference element.

In an embodiment, the second component is connected electrically in series with the piezoelectric or inductive transducer element. In this way, there results a measurement branch symmetric with the reference branch containing the reference element.

In an embodiment, the first component and the second component are variable resistors, especially digital potentiometers.

In an embodiment, the size of the second component is adjustable in such a manner that the electromechanical transducer unit has a predeterminable time constant. For the case, in which the second component is a variable resistor and the transducer element is a piezoelectric element, the time constant of the transducer unit is predetermined by the capacitance of the piezoelectric transducer element and by the resistance value. Correspondingly, the time constant is determined in the case of an inductive transducer element by the resistance value and the inductance of the inductive transducer element.

In an embodiment, in which the transducer unit has at least one piezoelectric transducer element, the reference element includes at least one capacitor or at least one piezoelectric element. In an embodiment, in which the transducer unit has at least one inductive transducer element, the reference element includes at least one coil. The reference element is either embodied equally to the electromechanical transducer unit in the measurement branch or it represents an electrical equivalent circuit of the transducer unit. In the simplest case, the reference element is composed, consequently, of a capacitor and a resistor, respectively of a coil and a resistor, wherein the size of the resistance is here electrically adjustable.

In an embodiment, the electronics unit includes a control system, which controls the size of the first component to the value, in the case of which a magnitude of a disturbance signal is minimal in the wanted signal extracted from the received signal and the reference signal. Minimal means here preferably zero. In other words, the control system controls the size of the first component in such a manner that the received signal and the reference signal differ only by the wanted signal. Only in the case of a non-optimal adjusting of the first component is there superimposed on the wanted signal a disturbance signal attributable to different time constants of the transducer unit and the reference element.

An embodiment provides that the electronics unit determines the temperature of the piezoelectric or inductive, transducer element.

In an embodiment, the electronics unit includes a memory unit, in which a characteristic curve is stored, which shows a dependence of the controlled value of the size of the first component on the temperature of the transducer element, so that the temperature is determinable based on the controlled value and the characteristic curve.

An embodiment provides that the reference element and the electromechanical transducer unit comprise an equal number of piezoelectric elements or coils, that a temperature sensor is provided, which determines temperature at the site of the reference element, that the electronics unit determines the temperature difference between the transducer element and the reference element based on the disturbance signal contained in the wanted signal, and that the electronics unit determines the temperature of the transducer element based on the temperature at the site of the reference element and the temperature difference. Preferably, the electronics unit determines the temperature difference, in such case, from the value of the first component controlled for adjusting the time constant.

Another embodiment of the apparatus includes that the apparatus monitors an exceeding or subceeding of a predetermined limit value of the process variable, that in the electronics unit of the apparatus for a predetermined temperature range, in which the apparatus is applicable, threshold values are stored, which the process variable dependent, oscillatory characteristic has in the case of reaching the limit value at the respective temperatures, and that the electronics unit monitors the exceeding or subceeding of the predetermined limit value based on the temperature ascertained in temperature measurement operation and the threshold value associated with this temperature.

In an embodiment, the electronics unit supplies the electromechanical transducer unit and the reference element in temperature measurement operation with an auxiliary signal, which has a frequency, which lies outside a resonance range around the resonant frequency of the oscillatable unit, and determines the temperature of the transducer element at least from the wanted signal extracted from the received signal and the reference signal in the supplying with the auxiliary signal. In this embodiment, a distinction is made between measurement operation and temperature measurement operation. During measurement operation, the transducer unit and reference element are supplied with the exciter signal, so that the oscillatable unit executes oscillations at its eigenfrequency, or resonant frequency. During temperature measurement operation, an auxiliary signal is supplied, whose frequency or frequencies lie above the resonance range. Measurement operation and temperature measurement operation happen either simultaneously, wherein the auxiliary signal is part of the exciter signal, or in different time intervals, wherein the electronics unit supplies the electromechanical transducer unit and the reference element alternately with the exciter signal and with the auxiliary signal. For example, in the case of a rectangular signal, the auxiliary signal is automatically part of the exciter signal in the form of higher frequency oscillation fractions.

The invention will now be explained in greater detail based on the appended drawing, the figures of which show as follows:

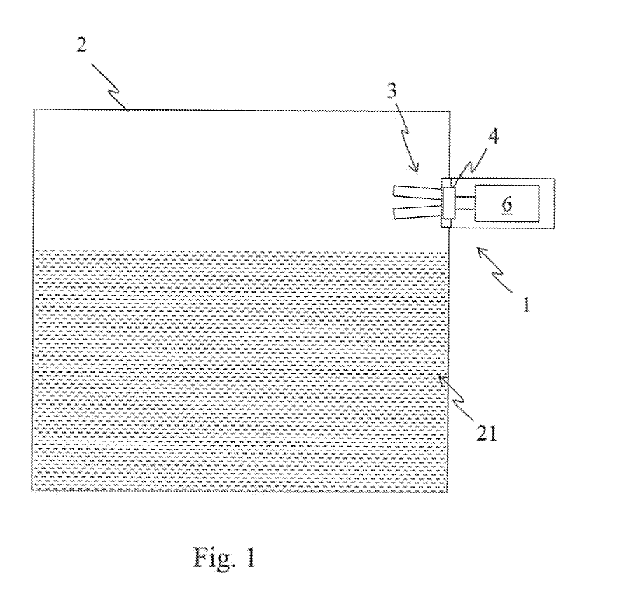

FIG. 1 an apparatus for monitoring fill level in a container;

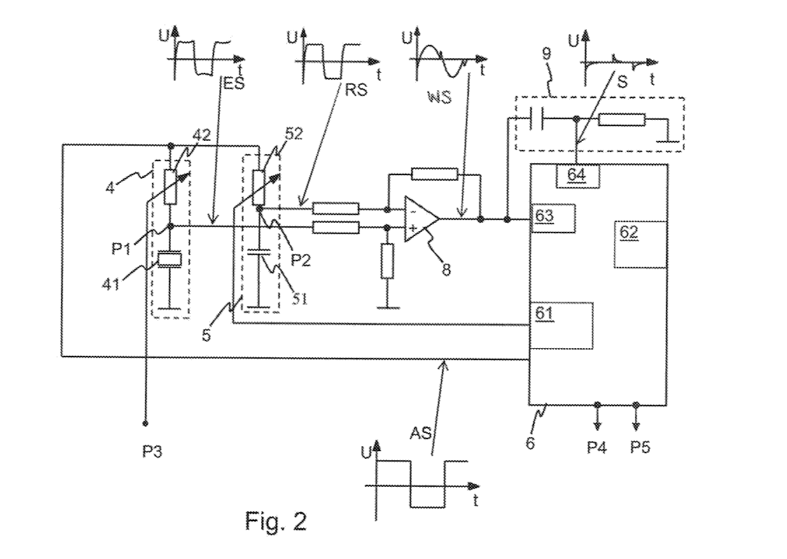

FIG. 2 a circuit diagram of a first embodiment of an apparatus of FIG. 1 with a piezoelectric transducer element;

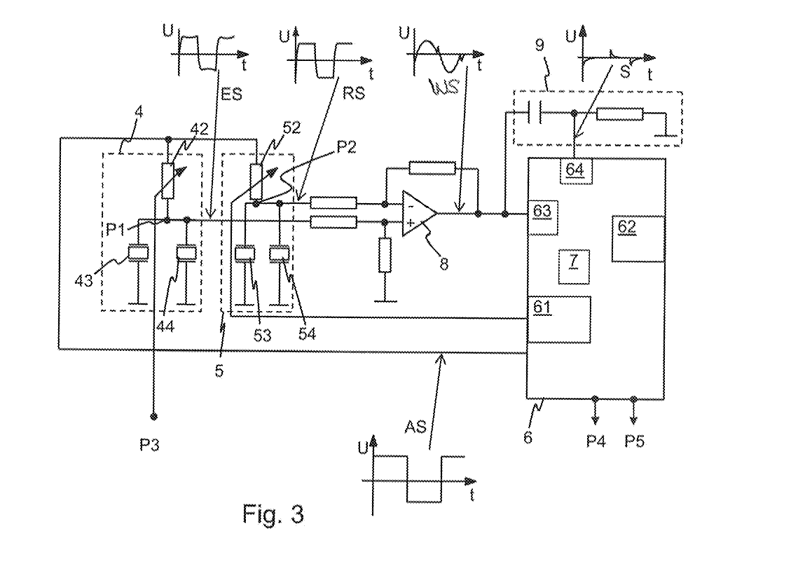

FIG. 3 a circuit diagram of a second embodiment of an apparatus of FIG. 1 with two piezoelectric transducer elements; and

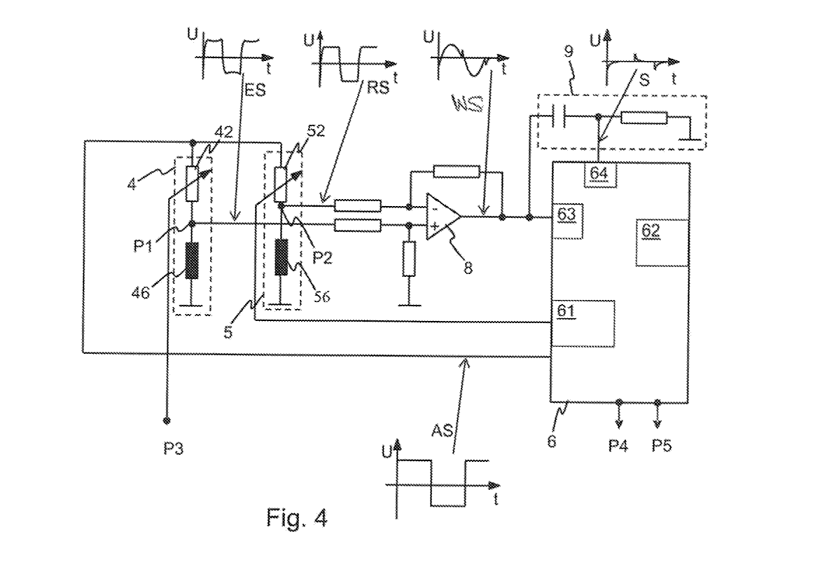

FIG. 4 a circuit diagram of a third embodiment of an apparatus of FIG. 1 with an inductive transducer element.

FIG. 1 shows an apparatus 1 for determining and/or monitoring a predetermined fill level, the density or the viscosity of a medium 21 in a container 2. The oscillatable unit 3 is formed as a fork of two rods, or tines, which are coupled with one another via a membrane and excitable via such to execute mechanical oscillations. Apparatus 1 is introduced in such a manner into the container 2 that the oscillatable unit 3 is located at a height, which corresponds to the fill level to be monitored. Arranged on the rear side of the membrane facing away from the medium 21 is an electromechanical transducer unit 4, which excites the oscillatable unit 3 to execute oscillations and receives mechanical oscillations from such and converts them into an electrical, received signal.

Known from the state of the art are various embodiments of an electromechanical transducer unit 4 with one or more piezoelectric transducer elements 41, 43, 44. In one-piezo technology, in the case of which the transducer element serves equally as transmitter and receiver, applied, above all, are an embodiment with a disk shaped transducer element 41 arranged centrally on the circularly shaped membrane and an embodiment with two circular section shaped transducer elements 43, 44, which are arranged symmetrically to one another on membrane halves. Both embodiments enable oppositely sensed oscillation of the two oscillatory rods about a longitudinal axis.

An alternative is provided by inductive transducer elements in the form of coils. Most often, a sending coil and a separate receiving coil are present. If disturbance signals in the received signal are compensated, also here one coil can serve both as transmitter as well as also as receiver. The two oscillatory rods of the oscillatable unit 3 have, for example, in the direction of the housing interior, in each case, a rod-shaped projection of a magnetic material, which protrudes into the magnetic field of the inductive transducer element 46. By applying an alternating voltage on the inductive transducer element 46, the oscillatory rods are excitable to execute opposite phase, bending oscillations.

The exciting to execute mechanical oscillations occurs, for example, by means of an electrical oscillatory circuit, wherein the received signal is fed back to the transducer unit as exciter signal via at least one phase shifter and one amplifier. Via the phase shifter, a fixed phase shift between exciter signal and received signal is predeterminable, so that, for example, for fill level measurement, a value for the phase shift is adjustable, in order to fulfill the condition for resonance.

Alternatively, the exciting occurs via a so-called frequency sweep, wherein the exciter signal passes in discrete steps repeatedly through a predetermined frequency band and, in such case, also passes through the resonant frequency.

For fill-level monitoring, the electromechanical transducer unit 4 excites the oscillatable unit 3 to execute resonant oscillations. Located in the electronics unit is at least one control/evaluation unit 6, for example, in the form a microcontroller or an FPGA (field programmable gate array). The control/evaluation unit 6 evaluates the electrical, received signal in reference to the fill level by comparing the oscillation frequency with a predetermined limit frequency. If the oscillation frequency lies below the limit frequency, the oscillatable unit 3 is covered with medium 21; if it lies above, the oscillatable unit 3 is oscillating freely.

For determining and/or monitoring density or viscosity of the medium 21, the control/evaluation unit 6, in the presence of immersed oscillatable unit 3, evaluates the oscillation frequency, the amplitude and/or the phase shift between exciter signal and received signal. The formulas for ascertaining the process variables from the oscillation characteristics are furnished in a memory unit 62 in the control/evaluation unit 6.

The invention will now be explained using the example of an oscillatory fork. However, the principles are likewise applicable in the case of measuring devices with an oscillatable unit 3 in the form of one oscillatory rod or just an oscillatory membrane.

FIG. 2 shows the invention based on a circuit diagram of a first variant of the apparatus 1. The shown electronics unit includes both analog as well as also digital components.

A signal generator produces an exciter signal AS and supplies it to a measurement branch and to a reference branch.

Arranged in the measurement branch is an electromechanical transducer unit 4 having a piezoelectric transducer element 41, which, by means of the exciter signal AS, excites the oscillatable unit 3 to execute oscillations. The piezoelectric transducer element 41 has two electrodes, wherein one of the electrodes is connected with ground and the other electrode is supplied with the exciter signal AS via an electrical resistor of electrically adjustable size. The adjustable resistor is implemented by a second digital potentiometer 42. Transducer element 41 and second digital potentiometer 42 form an RC-unit, whose time constant is given by the product of the electrical resistance of the digital potentiometer 42 and the capacitance of the transducer element 41.

The exciter signal AS is an electrical alternating voltage, for example, in the form of a rectangular signal. The exciter signal AS causes the piezoelectric transducer element 41 of the transducer unit 4 to execute periodic thickness oscillations, which are accompanied by corresponding oscillations of the diameter. The transducer element 41 is secured in such a manner to the membrane of the oscillatable unit 3 that the membrane oscillates with an oil-canning motion. In turn, the movement of the membrane causes the oscillatory rods to execute oscillations of opposite phase. The oscillation parameters depend, in such case, on the process variable. The mechanical oscillations are converted by the transducer element 41 into an electrical, received signal ES, which represents a superpositioning of a wanted signal WS and a disturbance signal, wherein the disturbance signal is to be attributed to reverse charging electrical currents in the piezoelectric transducer element 41 due to the polarity change of the exciter signal AS. The wanted signal WS results from charge reversal currents caused by the mechanical oscillations of the piezoelectric transducer element 41. The tap P1 of the received signal ES is located between the transducer element 41 and the second digital potentiometer 42.

Located in a reference branch supplied in parallel with the measurement branch with the exciter signal AS is a reference element 5 in the form of a series circuit of a capacitor 51 and a first digital potentiometer 52. Reference element 5 mimics the electrical behavior of the transducer unit 4 as supplied with the exciter signal AS in the wanted frequency range. The reference element 5 shown here represents the simplest form of an electrical equivalent circuit for the transducer unit 4. In an alternative embodiment, the reference element 5 includes for simulation of the transducer unit 4 other electrical components, for example, one or more electrical resistances and/or coils.

Located between the first digital potentiometer 52 and the capacitor 51 is the tap P2 for the reference signal RS. The reference signal RS is influenced only by the characteristic variables of the reference element 5 and is independent of the oscillations of the oscillatable unit 3. Reference signal RS contains only the disturbance signal, which results from charge reversal currents caused by the exciter signal AS. The disturbance signal follows sectionally rising and falling, exponential functions with a time constant predetermined by the parameters of the reference branch. Same holds correspondingly for the disturbance signal in the received signal ES. If the time constants of the reference branch and the measuring branch are equal, then also the disturbance signals are equal.

The second digital potentiometer 42 in the measurement branch is tuned in such a manner that the RC-unit formed from second digital potentiometer 42 and transducer element 41 has a predetermined time constant at a known reference temperature. The capacitance of the capacitor 51 and the resistance of the first digital potentiometer 52 are selected, respectively tuned, in such a manner that the reference element 5 has at the reference temperature the same time constant as the RC-unit of the measurement branch. The disturbance signals in the received signal ES and in the reference signal RS thus cancel and the reference signal RS and the received signal ES differ only by the oscillation dependent, wanted signal WS.

In order to extract the wanted signal WS, the received signal ES and the reference signal RS are fed to a difference amplifier 8. The reference signal RS is applied, in such case, on the inverting input. The output signal of the difference amplifier forms the wanted signal WS. The wanted signal WS is fed via a feedback resistor to the inverting input of the difference amplifier 8. Instead of the difference amplifier 8, also an adder can be used, to which are fed the received signal ES and an inverted reference signal RS.

The first digital potentiometer 52 produces overshooting in the charge reversal currents. Their compensation by a subsequent signal processing would be very complicated. In the present invention, instead of an unchanging ohmic resistance, an equally constructed digital potentiometer 42 is placed in the measurement branch. This produces the same overshooting as the first digital potentiometer 52, so that the overshooting is canceled by the difference forming for producing the wanted signal WS.

A further advantage, which results for the manufacturer by the use of the second digital potentiometer 42 is that the value for the time constant of the RC-unit in the measurement branch is tunable to a predetermined value, in spite of fluctuations of the capacitance values of equally constructed transducer elements 41. Reference element 5 then does not need to be tuned for each individual, otherwise equally constructed apparatus to a particular time constant. The optimal adjusting of the first digital potentiometer 52 need only be done once and can then be assumed for each electronics unit. The terminology, optimal adjusting, means, in such case, that, for adjusting the time constant of the reference element 5 for the transducer unit 4 over the total temperature range, the entire available value range of the first digital potentiometer 52, e.g. 0-50 kOhm, is used. The tuning of the second digital potentiometer 42 occurs electronically via the control port P3.

The wanted signal WS is fed to an analog-digital converter 63 of control/evaluation unit 6, which evaluates the wanted signal WS in measurement operation with reference to the process variable. The value of the process variable is available on port P4. In a variant, in the case of which the exciting of the oscillatable unit 3 occurs via an oscillatory circuit, the wanted signal WS is fed via an amplifier and a phase shifter to the transducer unit 4 and to the reference element 5 as exciter signal AS. The phase shifter is controlled in such a manner that the condition for resonance is fulfilled in the oscillatory circuit. In another variant, especially in the case of digital exciting by means of a frequency sweep, the control/evaluation unit 6 produces the exciter signal AS.

At the reference temperature, the oscillation independent part of the received signal ES and the reference signal RS do not differ. The capacitance of the transducer element 41 is, however, temperature dependent. This dependence effects a temperature dependent time constant of the RC-unit formed of transducer element 41 and second digital potentiometer 42. The changed time constant changes the charge reversal curve of the disturbance signal superimposed on the wanted signal WS. The capacitor 51 in the reference branch, in contrast, is temperature stable. Because of the temperature independent capacitance of the capacitor 51, the reference signal RS exhibits, thus, no such temperature dependence and the disturbance signals in received signal ES and reference signal RS no longer cancel in the case of a temperature change. The wanted signal WS includes then a disturbance signal S as signal portion, which must be compensated.

The compensation of the disturbance signal S occurs by means of the first digital potentiometer 52. The time constant of the reference element 5 is actively controllable by the first digital potentiometer 52 in such a manner that the time constant of the reference element 5 is matched permanently to that the transducer unit 4. The process variable is, thus, determinable with high accuracy even in the case of temperature changes. For controlling the tuning of the first digital potentiometer 52, a control system 61 controls the value of the first digital potentiometer 52, for example, in such a manner that the disturbance signal S contained in the wanted signal WS has a minimum amplitude. Preferably, the amplitude disappears, i.e. the wanted signal WS then contains no disturbance signal S. In this state, the time constants of measurement branch and reference branch are equal and the disturbance signal in the received signal ES is completely canceled.

For determining the amplitude of the disturbance signal S, the wanted signal WS is fed to a highpass filter 9, which filters the disturbance signal S out of the wanted signal WS. The highpass 9 is preferably adaptively constructed and preferably implemented as a notch filter. The disturbance signal S is fed via an analog-digital converter 64 to the control/evaluation unit 6. Preferably, the control/evaluation unit 6 samples the disturbance signal S at predetermined points in time. The predetermined points in time are defined relative to the exciter signal AS and correspond to points in time, at which the exciter signal AS has a zero crossing. The sampled values correspond to the amplitude of the disturbance signal S.

Due to the temperature dependence of the amplitude of the disturbance signal S contained in the wanted signal WS, the disturbance signal S can furthermore also be utilized for determining the temperature of the transducer element 41.

In an embodiment, the control/evaluation unit 6 determines directly from the amplitude of the disturbance signal S the temperature at the site of the transducer element 41, for example, based on a characteristic curve furnished in the memory unit 62.

In another embodiment, the control/evaluation unit 6 determines the temperature indirectly based on the control of the first digital potentiometer 52. In the case of minimum amplitude of the disturbance signal S, the time constants of the RC-units in the measurement branch and in the reference branch are essentially the same. If the disturbance signal S disappears completely, then the electromechanical transducer unit 4 and the reference element 5 have the same time constants. The control/evaluation unit 6 determines the temperature, for example, from the value of the electrical resistance of the first digital potentiometer 52 present after the control. Determinable from the established resistance value are the time constants of the two RC-units and therefrom the capacitance of the transducer element 41. A unique relationship exists between the capacitance and the temperature at the site of the transducer element 41. This is furnished in the form of a formula or a characteristic curve in the memory unit 62 of control/evaluation unit 6.

The temperature measured value is tappable via the port P5. The temperature information is utilized advantageously by the control/evaluation unit 6 in determining or monitoring the process variable. Since the oscillation characteristics of the oscillatable unit 3 can have a temperature dependence, preferably there are furnished in the memory unit 62 characteristic curves, which show the dependence of the oscillation characteristics on temperature and are taken into consideration in determining the process variable. For example, for fill-level monitoring, an associated limit frequency is furnished for each temperature value. The control/evaluation unit 6 selects as a function of the measured temperature at the site of the transducer element 41 the corresponding limit frequency, with which it compares the measured oscillation frequency, in order to provide a statement concerning the exceeding or subceeding of the limit level.

Alternatively, for simultaneous measuring of process variable and temperature, temperature measurement occurs in a temperature measurement operation. In temperature measurement operation, the signal generator supplies the transducer unit 4 and the reference element 5 with an auxiliary, or help, signal HS. The frequency of the auxiliary signal HS lies outside a resonance range around the resonant frequency of the oscillatable unit 3. In the case of supplying transducer unit 4 and reference element 5 only with the auxiliary signal HS, the received signal ES has no oscillation dependent fractions. If the temperature at the site of the transducer element 41 corresponds to the reference temperature, then reference signal RS and received signal ES are identical and the oscillation caused, wanted signal WS disappears. In the case of a changed temperature, the reference element 5 and the transducer unit 4 are no longer matched and there arises a wanted signal WS identical to the disturbance signal S. The amplitude of the wanted signal WS in the case of the exciting with the auxiliary signal HS is a direct measure for the capacitance of the transducer element 41 and, thus, also for the temperature at the site of the transducer element 41.

If the measurement operation is periodically interrupted for the temperature measurement operation, then applied to the transducer unit 4 and to the reference element 5 is a signal with a periodically repeatedly varying frequency, whose periods comprise, respectively, first and second, sequentially leading or following, time ranges. In the first time range, the signal is the exciter signal AS. In such case, the frequency of the signal rises or falls over time, in case the exciting occurs by means of a frequency sweep, or the frequency corresponds to the resonant frequency of the oscillatable unit 3. In the second time range, the signal is the auxiliary signal HS. In such case, the frequency of the signal is constant and lies outside of the frequency range predetermined by the resonant frequency of the oscillatable unit 3. Exciter signal AS and auxiliary signal HS are, for example, sinusoidal, trapezoidally shaped, triangle shaped or rectangular signals. A highpass filter is not required in this embodiment, since the wanted signal WS during temperature measurement operation corresponds to the disturbance signal S. The control system 61 controls, in this variant, the resistance of the first digital potentiometer 52 in such a manner that the magnitude of the amplitude of the wanted signal WS is minimum in temperature measurement operation. Other details for temperature determination by means of an auxiliary signal HS are set forth in German Patent Application No. 102010030791.2 (US 20130104647 (A1)).

FIG. 3 shows the circuit diagram of a second variant of the apparatus 1. Instead of the series circuit of first digital potentiometer 52 and capacitor 51, the reference element 5 is composed here of a digital potentiometer 52 and two piezoelectric transducer elements 53, 54, in the following called the compensation piezos. Since two transducer elements 43, 44 are arranged in the measurement branch, the reference element 5 has correspondingly likewise two compensation piezos 53, 54. The compensation piezo 53, 54 are of equal construction to the transducer elements 43, 44 in the measurement branch. By way of the compensation piezos 53, 54, formed with measurement branch and reference branch are two identical branches, which at the reference temperature have the same time constants and the same temperature and aging behavior. The compensation piezos 53, 54 are, in contrast to the transducer elements 43, 44, independent of the oscillations of the oscillatable unit 3. In measuring and reference branches, there occur the same parasitic effects, so that these effects, in producing the wanted signal WS by means of the difference amplifier 8, are ideally completely canceled.

Compensation piezos 53, 54 and transducer elements 43, 44 originate preferably from the same batch. Within a batch, temperature behavior and aging behavior are identical. The basic capacitances of the compensation piezos 53, 54 and the transducer elements 43, 44 can differ, while the percent change of the capacitance in the case of a temperature change does not, however, differ.

The capacitances of the compensation piezos 53, 54 are subject, same as those of the transducer elements 43, 44, to temperature influences. As a result thereof, in this embodiment, only the temperature difference between reference element 5 and transducer elements 43, 44 is measurable by means of the disturbance signal S contained in the wanted signal WS. In order based on the measurable temperature difference to be able to make a statement concerning the temperature reigning at the site of the transducer elements 43, 44, the temperature at the site of the reference element 5 must be known. For this, a temperature sensor 7 is arranged in the electronics unit in the vicinity of the reference element 5. For example, the temperature sensor 7 is integrated into the control/evaluation unit 6. The control/evaluation unit 6 is preferably at least partially embodied as a microcontroller. Often, a microcontroller is already equipped with a temperature sensor 7, so that the temperature, in this case, is already known and no separate temperature sensor is required.

FIG. 4 shows a circuit diagram of a variant of the apparatus with an inductive transducer element 46 instead of a piezoelectric transducer element 41 in the case of digital exciting. The control/evaluation unit 6 produces the exciter signal AS, preferably in the form of a rectangular signal, and supplies it to the measurement branch and to the reference branch. Arranged in the measurement branch is the inductive transducer element 46, while in the reference branch the reference element 5 is equipped with the coil 56. The exciter signal is fed to the coil 56 via the electrically variable resistor in the form of the first digital potentiometer 52 and to the inductive transducer element 46 via the second digital potentiometer 42. The received signal ES of the transducer unit 4 and the reference signal RS of the reference element 5 are fed to the difference amplifier 8, which forms the difference signal for producing the wanted signal WS. The control/evaluation unit 6 determines the process variable from the wanted signal WS.

Analogously to the preceding embodiments, the time constant of the RL-unit in the measurement branch is adjustable to a predetermined size via the value of the second digital potentiometer 42. The first digital potentiometer 52 is controllable during operation of the measuring device 1 in such a manner that the RL-unit in the reference branch always has the same time constant as the corresponding unit in the measurement branch. Disturbance signals S in the wanted signal WS due to different time constants are thereby eliminated. Also in this variant, the control/evaluation unit 6 filters disturbance signals S contained in the wanted signal WS in the case of incomplete compensation out of the wanted signal WS, controls the value of the first digital potentiometer 52 in such a manner that an amplitude of the disturbance signals S is minimum, and determines preferably furthermore the temperature of the inductive transducer element 46 based on the adjusting of the first digital potentiometer 52.

In an embodiment for improved adjusting of the transfer behavior of the reference element 5 relative to the transfer behavior of the transducer unit 4 with the inductive transducer element 46, the reference element 5 is composed not only of the first digital potentiometer 52 and the coil 56, but, instead, contains other components. For example, the reference element 5 is composed of a first variable digital potentiometer 52, a coil 56, a capacitor and an electrical resistor of fixedly predetermined size.

### LIST OF REFERENCE CHARACTERS

1 measuring device
2 container
21 medium
3 oscillatable unit
4 transducer unit
41 piezoelectric transducer element
42 second digital potentiometer
43 first transducer element
44 second transducer element
46 inductive transducer element
5 reference element
51 capacitor
52 first digital potentiometer
53 first compensation piezo
54 second compensation piezo
56 coil
6 control/evaluation unit
61 control system
62 memory unit
63, 64 analog-digital converters
7 temperature sensor
8 difference amplifier
9 highpass
P1 tap ES
P2 tap RS
P3 control port
P4 output process variable
P5 output temperature

1-11. (canceled)

12. An apparatus for determining and/or monitoring at least one process variable of a medium in a container, comprising:
a mechanically oscillatable unit;
an electromechanical transducer unit, which has at least one piezoelectric transducer element or inductive transducer element, which excites the oscillatable unit by means of an exciter signal to execute mechanical oscillations and which receives oscillations from the oscillatable unit and converts them into an electrical, received signal, said received signal exhibits a superpositioning of a disturbance signal and a wanted signal representing the oscillations;
a reference element having a component of electrically adjustable size, wherein the reference element is connected in parallel with the electromechanical transducer unit and supplied with the same exciter signal and produces a reference signal uninfluenced by the oscillations of the oscillatable unit; and
an electronics unit, which in the case of a supplying of the electromechanical transducer unit and the reference element with the exciter signal extracts the wanted signal from the received signal and the reference signal and, based on the wanted signal, determines and/or monitors the process variable; wherein:
said electromechanical transducer unit includes a second component of electrically adjustable size.

13. The apparatus as claimed in claim 12, wherein:
said second component is connected electrically in series with said piezoelectric transducer element or inductive transducer element.

14. The apparatus as claimed in claim 12, wherein:
said first component and said second component are variable resistors, especially digital potentiometers.

15. The apparatus as claimed in claim 12, wherein:
the size of said second component is adjustable in such a manner that said electromechanical transducer unit has a predeterminable time constant.

16. The apparatus as claimed in claim 12, wherein:
for the case, in which said transducer unit has at least one piezoelectric transducer element, said reference element has at least one capacitor or at least one piezoelectric element, and, for the case, in which said transducer unit has at least one inductive transducer element, said reference element has at least one coil.

17. The apparatus as claimed in claim 12, wherein:
said electronics unit includes a control system, which controls the size of said first component to the value, in the case of which a magnitude of a disturbance signal is minimum in the wanted signal extracted from the received signal and the reference signal.

18. The apparatus as claimed in claim 12, wherein:
said electronics unit determines the temperature of said piezoelectric or inductive, transducer element.

19. The apparatus as claimed in claim 17, wherein:
said electronics unit includes a memory unit, in which a characteristic curve is stored, which shows a dependence of the controlled value of the size of said first component on the temperature of said transducer element, so that the temperature is determinable based on the controlled value and the characteristic curve.

20. The apparatus as claimed in claim 12, wherein:
said reference element and said electromechanical transducer unit comprise an equal number of piezoelectric elements or coils, a temperature sensor is provided, which determines the temperature at the site of said reference element;
said electronics unit determines the temperature difference between said transducer element and said reference element based on the disturbance signal contained in the wanted signal; and
said electronics unit determines the temperature of said transducer element based on the temperature at the site of said reference element and the temperature difference.

21. The apparatus as claimed in claim 12, wherein:
said apparatus monitors an exceeding or subceeding of a predetermined limit value of the process variable, in the electronics unit of the apparatus for a predetermined temperature range, in which the apparatus is applicable, threshold values are stored, which the process variable dependent, oscillatory characteristic has in the case of reaching the limit value at the respective temperatures; and
said electronics unit monitors the exceeding or subceeding of the predetermined limit value based on the temperature ascertained in the temperature measurement operation and the threshold value associated with this temperature.

22. The apparatus as claimed in claim 18, wherein:
said electronics unit supplies the electromechanical transducer unit and said reference element in temperature measurement operation with an auxiliary signal, which has a frequency, which lies outside a resonance range around the resonant frequency said oscillatable unit, and determines the temperature of said transducer element at least from the wanted signal extracted from the received signal and the reference signal in the supplying with the auxiliary signal.
